(19) United States
(12) Patent Application Publication
(10) Pub. No.: US 2015/0293951 A1
(43) Pub. Date: Oct. 15, 2015

(54) CONTROL METHOD, COMPUTER PRODUCT, AND CONTROL APPARATUS

(71) Applicant: FUJITSU LIMITED, Kawasaki-shi (JP)

(72) Inventor: Hironobu Yamasaki, Kawasaki (JP)

(21) Appl. No.: 14/751,490

(22) Filed: Jun. 26, 2015

Related U.S. Application Data
(63) Continuation of application No. PCT/JP2013/050340, filed on Jan. 10, 2013.

(51) Int. Cl. G06F 17/30

(52) U.S. Cl. CPC G06F 17/30303; G06F 17/30598; G06F 17/30256

(57) ABSTRACT

A control method is executed by a computer that classifies given data into a group according to a property amount of a given type among property amounts of various types that the given data has and that stores the given data to a storage device. The control method includes writing to the storage device and for each group, information that indicates distribution positions of the property amounts in the classified given data; calculating based on the written information, information that indicates a proximity of the distribution positions of the property amounts between the groups; and classifying data of the same type as the given data into a group, according to a property amount of a different type from the given type among the various types of property amounts, when the calculated information satisfies a given condition, and storing the data to the storage device.

### CROSS REFERENCE TO RELATED APPLICATIONS

This application is a continuation application of International Application PCT/JP2013/050340, filed on Jan. 10, 2013 and designating the U.S., the entire contents of which are incorporated herein by reference.

### FIELD

The embodiments discussed herein are related to a control method, a computer product, and a control apparatus.

### BACKGROUND

According to a known technique, to reduce the load on a network when an image is distributed from a given user terminal to other user terminals, the given user terminal calculates a property amount from image data and transmits the image to the other user terminals (for example, refer to Japanese Laid-Open Patent Publication No. 2004-46641). A technique of grouping data according to the property amount is also known.

According to another known technique, to reduce the processing load at a mobile telephone, a proxy server analyzes, in place of the mobile telephone, content obtained from a content server in response to a browsing request for the content from the mobile telephone (for example, refer to Japanese Laid-Open Patent Publication No. 2005-56096).

Nonetheless, when data is grouped according to a property amount of the data, a problem arises in that the accuracy of classification drops depending on the types of property amounts.

### SUMMARY

According to an aspect of an embodiment, a control method is executed by a computer that classifies given data into a group among plural groups, the computer classifying the given data according to a property amount of a given type among property amounts of various types that the given data has and storing the given data to a storage device. The control method includes writing to the storage device and for each group among the plural groups, information that indicates distribution positions of the property amounts in the classified given data; calculating based on the written information that indicates the distribution positions of the property amounts, information that indicates a proximity of the distribution positions of the property amounts between groups among the plural groups; and classifying data of a same type as the given data into a group among the plural groups, according to a property amount of a different type from the given type among the various types of property amounts, when the calculated information that indicates the proximity between the distribution positions satisfies a given condition, and storing the data to the storage device.

The object and advantages of the invention will be realized and attained by means of the elements and combinations particularly pointed out in the claims.

It is to be understood that both the foregoing general description and the following detailed description are exemplary and explanatory and are not restrictive of the invention.

### BRIEF DESCRIPTION OF DRAWINGS

FIG. 1 is a diagram depicting an example in which types of property amounts are increased;

FIG. 2 is a diagram depicting an example in which the types of property amounts are decreased;

FIG. 3 is a block diagram depicting an example of hardware configuration of a control apparatus and a classifying apparatus according to an embodiment;

FIG. 4 is a diagram depicting a database that stores for each cluster, property amounts of various types;

FIG. 5 is a block diagram depicting a functional configuration of the classifying apparatus;

FIG. 6 is a diagram depicting clustering by a cluster analyzing unit;

FIG. 7 is a block diagram depicting a functional configuration of the control apparatus;

FIG. 8 is a flowchart depicting an example of a procedure of a clustering process by the classifying apparatus;

FIG. 9 is a flowchart depicting an example of a procedure of a control process by the control apparatus;

FIG. 10 is a flowchart depicting an example of details of the procedure of the control process by the control apparatus; and

FIG. 11 is a flowchart depicting another example of the details of the procedure of the control process by the control apparatus.

### DESCRIPTION OF EMBODIMENTS

Embodiments of a control method, a control program, and a control apparatus will be described in detail with reference to the accompanying drawings.

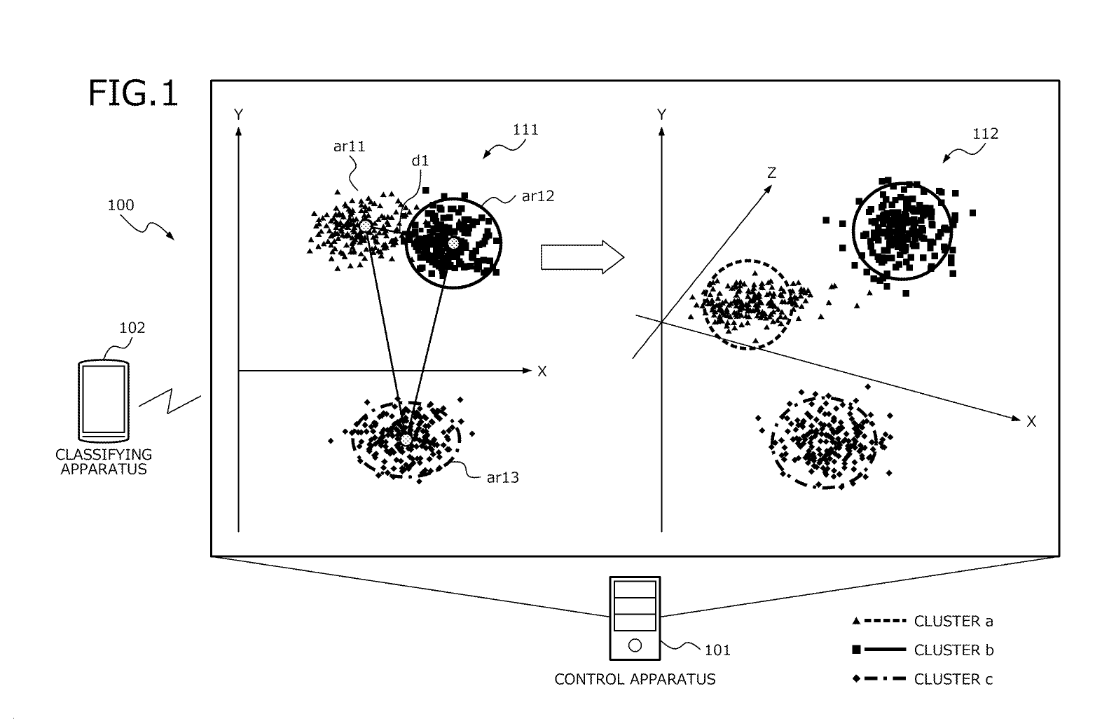

FIG. 1 is a diagram depicting an example in which the types of property amounts are increased. A system 100 depicted in FIG. 1, performs clustering and includes a control apparatus 101 and a classifying apparatus 102. In the example depicted in FIG. 1, data are respectively classified into three groups according to a property amount X and property amount Y that the data has. Graph 111 depicts distribution positions of a combination of the property amount X and the property amount Y of the data. Herein, these groups are referred to as clusters and the act of classifying is referred to as clustering. Clustering to label each audio data of a recorded meeting with a participant thereof is an example of a use of clustering. For example, recorded audio data can be given as an example of the data, and a participant in the meeting recorded into the audio data can be given as an example of a cluster.

The control apparatus 101 is a computer that controls the classifying apparatus 102, which is a computer that classifies a given data into a cluster among multiple clusters, according to the property amount of a given type among various types of property amounts of the given data. The given data is, for example, the audio data described above. The control apparatus 101 is, for example, a server. The classifying apparatus 102 is, for example, a mobile terminal apparatus. For example, plural types of property amounts can be obtained from digitized audio data, such as Mel-Frequency Cepstral Coefficient (MFCC), pitch, Glottal Pulse Rate (GPR), Vocal Tract Length (VTL). The classifying apparatus 102 can calculate the property amount of any of the types, and according to an instruction from the control apparatus 101, can change the type to be calculated among the various types. A given type among the various types is a type that among the types of property amounts that the classifying apparatus 101 can calculate, is arbitrarily or user specified, or has been instructed by the control apparatus 101 in the past. In the example depicted in FIG. 1, a given type may be one or more types.

For each cluster, the control apparatus 101 writes into a storage unit, information that indicates the distribution position of a property amount in given data. Here, the information is information that indicates the distribution position of a property amount in given data classified by the classifying apparatus 102. The information indicating the distribution position of a property amount may be received from the classifying apparatus 102, may be read out from an accessible storage apparatus by the control apparatus 101, or may be input through an input means by the user of the control apparatus 101. Here, the control apparatus 101 is assumed to receive the information related to the distribution position from the classifying apparatus 102. Further, the storage unit is a storage apparatus such as RAM and a disk of the control apparatus 101. The information indicating the distribution position of a property amount for a cluster, for example, may be the property amount itself of the data classified into the cluster, or information that indicates a distribution range of a property amount for a cluster obtained by modeling the property amount.

In the example depicted in FIG. 1, points shaped like triangles, squares, and diamonds in graphs 111 and 112 represent information related to distribution positions of normalized property amounts. The circles in graph 111 are information indicating distribution ranges ar11, ar12, ar13 for the clusters obtained by modeling using the normalized property amounts. Similarly, in graph 112, although reference numerals are not given, there is information that indicates distribution ranges for the clusters. More specifically, the information indicating the distribution ranges ar11, ar12, and ar13 suffices to indicate a center position, the length of the diameter of an ellipse, and the like. The information related to the distribution positions of property amounts may be a set of information, or discrete information as indicated by the information indicating each of the distribution ranges ar11, ar12, ar13 of the property amounts for the clusters.

The information related to the distribution positions of property amounts is normalized and therefore, units of the axes in graphs 111 and 112 depicted in FIG. 1 are the same and even if the type of property amount differs, the control apparatus 101 can compare the positions or lengths. Normalization may be performed by the classifying apparatus 102 or by the control apparatus 101. The values of the normalized property amounts are modeled by the classifying apparatus 102 at the time of clustering whereby, the volume of communication from the classifying apparatus 102 to the control apparatus 101 can be reduced.

The control apparatus 101 derives based on the information written into the storage unit and indicating the distribution positions of property amounts, information that indicates the proximity of distribution positions of property amounts, between clusters. The information indicating the proximity in the example depicted in FIG. 1 is information that indicates the extent of overlap of the distribution ranges ar11, ar12, and ar13. More specifically, the information is the length of a segment of the lines connecting the centers of the distribution ranges ar11, ar12, and ar13, included in an overlapping area. As described above, the information indicating the distribution ranges ar11, ar12, and ar13 is normalized and therefore, even property amounts of types that differ can be compared. In the example depicted in FIG. 1, although the information indicating the proximity of cluster a and cluster b is a length dl, the information indicating the proximity of cluster a and cluster c is 0, and the information indicating the proximity of cluster b and cluster c is 0.

Further, for example, information indicating the proximity may be the distance between the distribution positions of averages of the property amounts or the distance between the distribution positions of median values of each cluster. Alternatively, for example, information indicating the proximity may be the distance between distribution positions of property amounts whose distribution positions are closest among the property amounts for the clusters, or the distance between distribution positions of property amounts that are farthest.

The control apparatus 101 determines whether the derived information indicating the proximity satisfies a given condition. For example, the given condition prescribes the distribution positions to be closer than a predetermined proximity. The predetermined proximity is set by the designer of the control apparatus 101. In the example depicted in FIG. 1, for example, the control apparatus 101 determines whether dl, which is the information indicating the proximity of cluster a and cluster b, is a threshold or greater. The threshold may be a value set by the designer of the control apparatus 101 or a value input by the user through an input means. Further, the threshold is assumed to be stored in a storage apparatus that the control apparatus 101 can access.

The control apparatus 101, upon determining that the given condition is satisfied, performs control to cause the classifying apparatus 102 to cluster data of the same type as the given data into a cluster among the multiple clusters, according to the property amount of a type that differs from the given type among the property amounts of the various types. The data of the same type as the given data is data that has the same type of property amount as the given data, and may be the same data or different data. Selection of a type that differs from the given type among the various types will be described hereinafter. For example, the control apparatus 101 may transmit to the classifying apparatus 102, information indicating classification by a different type to control the classifying apparatus 102. As a result, the type of the property amount is changed, enabling classification accuracy to be improved.

Further, the control apparatus 101, upon determining that the given condition is satisfied, performs control to cause the classifying apparatus 102 to cluster data of the same type as the given data into a cluster among multiple clusters, according to the property amount of a type that has been added and differs from the given type. In graph 112, property amount Z has been added, and the axes have increased by one compared to graph 111. As a result, a type of property amount is added, enabling classification accuracy to be improved.

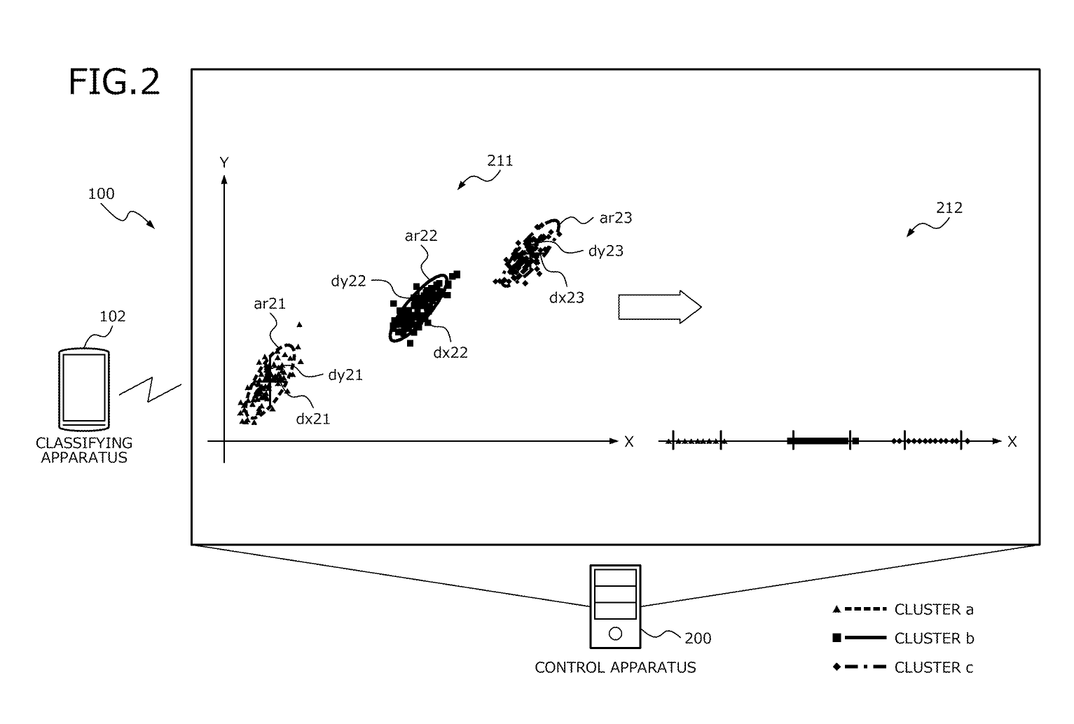

FIG. 2 is a diagram depicting an example in which the types of property amounts are decreased. A control apparatus 200 is a computer that controls the classifying apparatus 102, which is capable of clustering given data according to various types of property amounts that the given data has.

The control apparatus 200 writes into a storage unit, information that indicates the distribution positions of various types of property amounts that each data has. The data is the same as that in the example depicted in FIG. 1. Graph 211 depicts distribution positions of the combination of the property amount X and the property amount Y of each data. In the example depicted in FIG. 2, similar to the example described with reference to FIG. 1 and as depicted in graph 211, concerning the information that indicates distribution positions, information that indicates distribution ranges ar21, ar22, and ar23 may be obtained. Based on the written information indicating the distribution positions of various types of property amounts, the control apparatus 200 calculates for each combination of types, information that indicates the strength of correlation between the property amounts of the types included in the combination. More specifically, the control apparatus 200 calculates a correlation coefficient for each combination of types. The correlation coefficient indicates a stronger correlation between the two values of the combination as the value of the correlation coefficient approaches 1 or −1 and indicates a weaker correlation of the two values of the combination as the value of the correlation coefficient approaches 0.

The control apparatus 200 specifies among the combinations of types, a combination for which the correlation strength indicated by the calculated information is a predetermined strength or greater. The predetermined strength is assumed to be preset by the designer or user of the control apparatus 200. When the information indicating the strength of correlation is a correlation coefficient, the control apparatus 200 specifies among the combinations of types, a combination for which the absolute value of the calculated correlation coefficient is a given value or greater. The correlation coefficient for the property amount X and the property amount Y depicted in FIG. 2 is assumed to be a threshold or greater.

The control apparatus 200 performs control to cause the classifying apparatus 102 to classify given data into a cluster, according to the property amounts of types excluding from the various types, any one of the types included in the specified combination. As a result, classification accuracy is maintained while enabling classification by the least number of types of property amounts.

Further, the control apparatus 200 specifies, from among the types included in the specified combination, the type for which the extent of variation of the property value is greater. In the example depicted in FIG. 2, the control apparatus 200 measures the length of each distribution range along a direction parallel to each type. The control apparatus 200 sums the lengths measured for the types. In the example depicted in FIG. 2, the extent of variation for the property amount X is the total of dx21, dx22, and dx23; and the extent of variation for the property amount Y is the total of dy21, dy22, and dy23. Here, the calculated sum is assumed to be the extent of variation. In this case, the control apparatus 200 specifies as the type for which the extent of variation is greater, the type for which the sum is greater. In the example depicted in FIG. 2, since the sum for the property amount Y, which is the type in the vertical direction, is greater than the sum for the property amount X, which is the type in the horizontal direction, the control apparatus 200 specifies the property amount Y.

Further, the control apparatus 200 may perform control to cause the classifying apparatus 102 to classify given data into a cluster, according to the property amount of a type excluding from the multiple types, the specified type. In the example depicted in FIG. 2, the control apparatus 200 performs control to cause the classifying apparatus 102 to classify given data into a cluster, according to the property amount X. Graph 212 depicts an example of classification by the property amount X alone. As a result, the property amount of the type for which the variation is smaller achieves higher classification accuracy than the property amount of the type for which the variation is greater and therefore, classification is performed by a property amount that achieves high classification accuracy, enabling classification by the least number of types of property amounts.

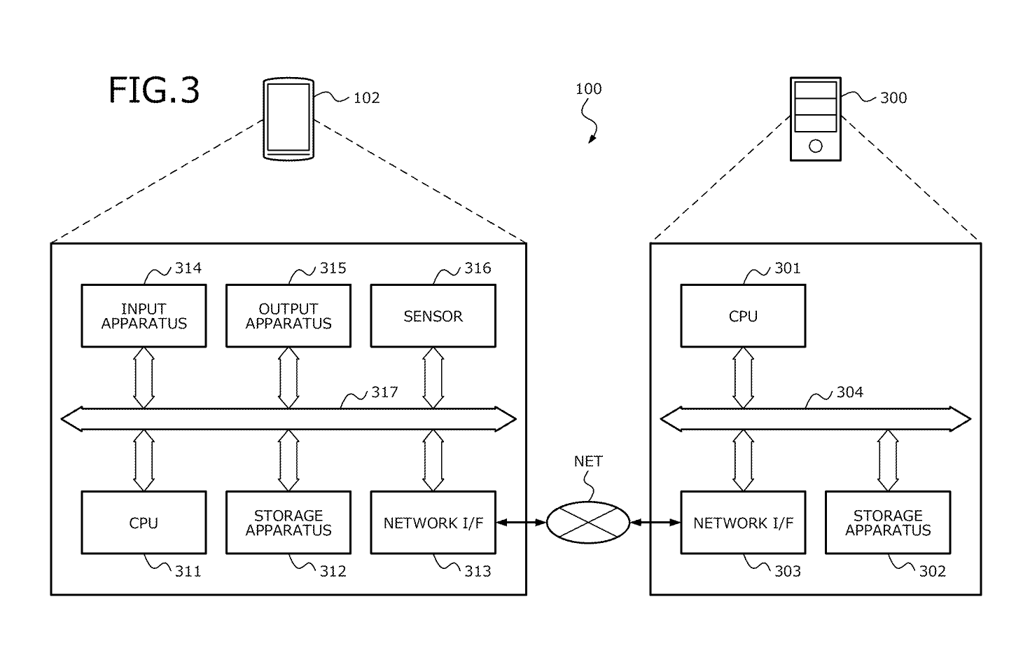

FIG. 3 is a block diagram depicting an example of hardware configuration of the control apparatus and the classifying apparatus according to the embodiment. The system 100 includes a control apparatus 300 and the classifying apparatus 102. Here, the control apparatus 300 is a computer having functions of the control apparatus 101 depicted in FIG. 1 and the control apparatus 200 depicted in FIG. 2. In FIG. 3, the control apparatus 300 includes a central processing unit (CPU) 301, a storage apparatus 302, and a network interface (I/F) 303, respectively connected by a bus 304.

Here, the CPU 301 governs overall control of the control apparatus 300. The CPU 301 executes various types of programs stored in the storage apparatus 302 and thereby, reads out data stored in the storage apparatus 302 and writes data such as execution results into the storage apparatus 302.

The storage apparatus 302 is a storage unit such as read-only memory (ROM), random access memory (RAM), flash memory, a magnetic disk drive, and the like. The storage apparatus 302 is used as a work area of the CPU 301 and stores various types of programs and data.

The network I/F 303 is connected, via a communications line, to a network NET such as a local area network (LAN), a wide area network (WAN), and the Internet and is connected to the classifying apparatus 102 via the network NET. The network I/F 303 administers an internal interface with the network NET and controls the input and output of data with respect to an external apparatus. A model, LAN adapter, and the like may be employed as the network I/F 303.

The classifying apparatus 102 includes a CPU 311, a storage apparatus 312, a network I/F 313, an input apparatus 314, an output apparatus 315, and a sensor 316, respectively connected by a bus 317.

Here, the CPU 311 governs overall control of the classifying apparatus 102. The CPU 311 executes various types of programs stored in the storage apparatus 312 and thereby reads out data stored in the storage apparatus 312 and writes data such as execution results into the storage apparatus 312.

The storage apparatus 312 may be ROM, RAM, flash memory, a magnetic disk drive, and the like. The storage apparatus 312 is used as a work area of the CPU 311 and stores various types of programs and data.

The network I/F 313 is connected, via a communications line, to the network NET such as a LAN, a WAN, and the Internet and is connected to the control apparatus 300 via the network NET. The network I/F 313 administers an internal interface with the network NET and controls the input and output of data with respect to an external apparatus. A model, LAN adapter, and the like may be employed as the network I/F 313.

The input apparatus 314 is an interface that inputs various types of data via user operation of a keyboard, a mouse, touch panel, and the like. The input apparatus 314 can further take in images and video from a camera.

The output apparatus 315 is an interface that outputs data according to an instruction of the CPU 311. The output apparatus 315 may be a display, a printer, and the like.

The sensor 316, for example, detects a given fluctuation at the installation site of the classifying apparatus 102. For example, the sensor 316 can detect sound, temperature, etc.

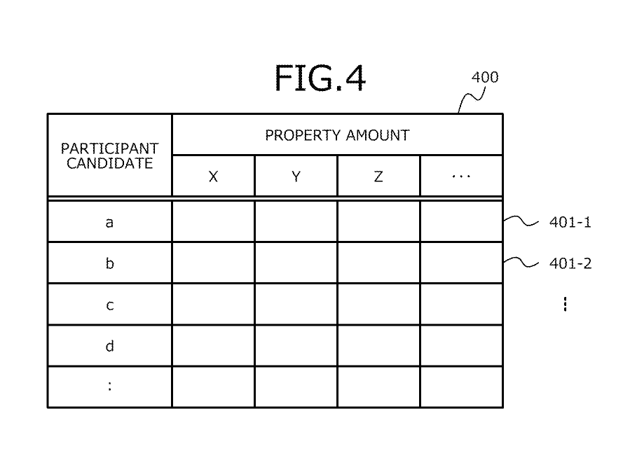

FIG. 4 is a diagram depicting a database that stores for each cluster, property amounts of various types. In this example, a cluster is assumed to be a participant candidate of a meeting. A database 400 has fields for participant candidates and distribution positions of various types of property amounts. By setting information into the respective fields, the information is stored as records (e.g., 401-1, 401-2, . . . ). The database 400 is realized by a storage apparatus.

For example, identification information indicating a candidate of participants of the meeting is registered in the participant candidate field. For example, information related to the distribution position of a property amount related to sound concerning participant candidates is registered in the property_amount distribution position field. Information related to the distribution position of a property amount related to sound, for example, is assumed to be property amounts that have been normalized and registered into the database 400 and even if the types of the property amounts differ, the property amounts are assumed to be able to be compared by the control apparatus 300.

Further, for example, information related to distribution positions for the types may be stored in the database 400. Further, for example, for each participant candidate, the smallest value and the greatest value of the distribution position of each type of property amount may be registered, and distribution ranges obtained by modeling the distribution positions of the property amounts may be registered.

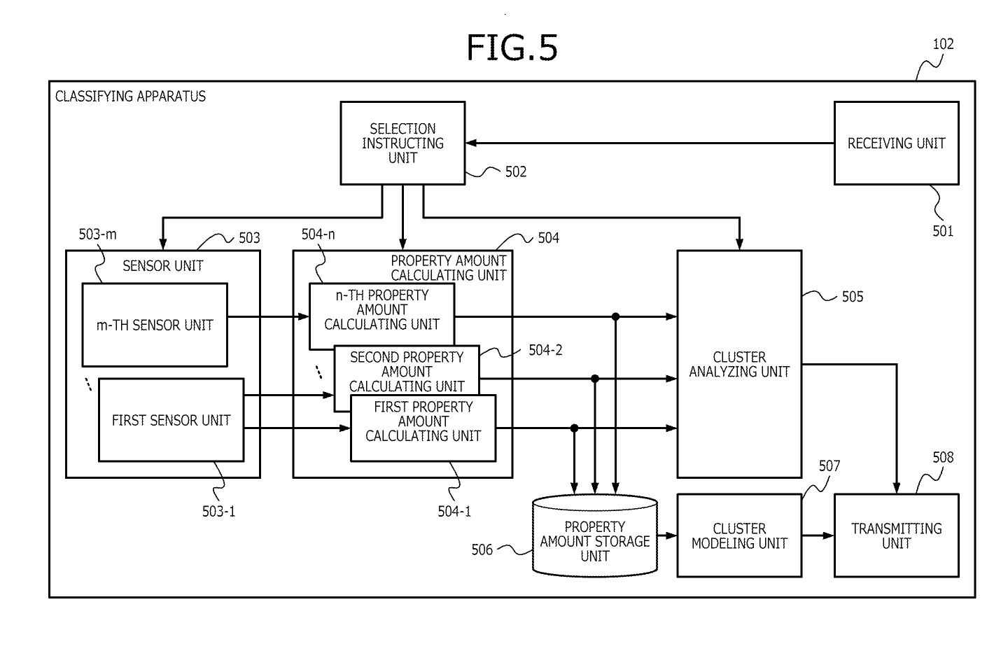

FIG. 5 is a block diagram depicting a functional configuration of the classifying apparatus. The classifying apparatus 102 includes a receiving unit 501, a selection instructing unit 502, a sensor unit 503, a property amount calculating unit 504, a cluster analyzing unit 505, a property amount storage unit 506, a cluster modeling unit 507, and a transmitting unit 508. The transmitting unit 508 and the receiving unit 501 are realized by the network I/F 313.

The selection instructing unit 502 to the cluster analyzing unit 505, and the cluster modeling unit 507 may be formed by elements such as a logical AND gate, an INVERTER that is a NOT gate, an OR gate, a flip flop (FF) that is a latch circuit, etc. Alternatively, processes of the selection instructing unit 502, the sensor unit 503, the property amount calculating unit 504, the cluster analyzing unit 505, and the cluster modeling unit 507, for example, are encoded in a classifying program stored in the storage apparatus 312 accessible by the CPU 311. The CPU 311 reads out the classifying program from the storage apparatus 312 and executes processes encoded in the classifying program whereby, the processes of the selection instructing unit 502, the sensor unit 503, the property amount calculating unit 504, the cluster analyzing unit 505, and the cluster modeling unit 507 may be realized.

The sensor unit 503 can detect fluctuation at the control apparatus 300. For example, as described with reference to FIG. 1, the fluctuation may be sound. For example, the sensor unit 503 detects sound. The sensor unit 503, for example, may be provided in plural such as first to m-th sensor units 503-1 to 503-m, where sound is detected by the respective sensor units 503. Which sensor unit 503 among the sensor units 503-1 to 503-m operates is assumed to be consequent to selection by the selection instructing unit 502.

The property amount calculating unit 504 can calculate various types of property amounts obtained from data related to the detection by the sensor unit 503. For example, the property amount calculating unit 504 can calculate property amounts for each type among the various types, where n types of property amounts are respectively calculated by first to n-th property amount calculating units 504-1 to 504-n. Selection of a property amount calculating unit 504 among the first to n-th the property amount calculating units 504-1 to 504-n is assumed to be by instruction from the selection instructing unit 502.

The cluster analyzing unit 505 performs clustering according to property amounts calculated by the property amount calculating units 504.

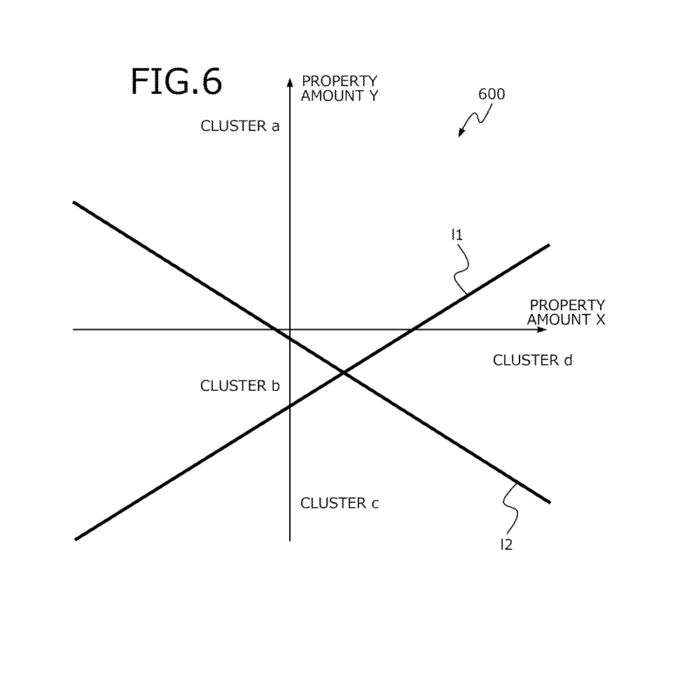

FIG. 6 is a diagram depicting clustering by the cluster analyzing unit. Graph 600 depicts clustering to a cluster by the distribution positions of the combination of the property amount X and the property amount Y obtained from data. For example, for each cluster, thresholds are predefined for various types of property amounts and the cluster analyzing unit 505 performs clustering by determining whether property amounts calculated by the property amount calculating units 504 are the thresholds or less. Diagonal lines 11 and 12 in graph 600 depicted in FIG. 6 indicate threshold values. For example, the control apparatus 300 performs clustering based on which area of clusters a to d in graph 600 includes the combination of the property amount X and the property amount Y that each data has.

The property amount storage unit 506 stores property amounts of a fixed period of time, calculated by the property amount calculating units 504. The fixed period of time is assumed to be set by the designer of the classifying apparatus 102. The property amount storage unit 506 is realized by the storage apparatus 312.

The receiving unit 501 receives from the control apparatus 300, information related to which type of property amount among the various types, clustering is to be based on. The receiving unit 501 may further receive from the control apparatus 300, the threshold values to be used when clustering is performed by the cluster analyzing unit 505.

Based on the information received by the receiving unit 501, the selection instructing unit 502 instructs the sensor units 503 as to which thereamong is to be executed and instructs the property amount calculating units 504 as to which thereamong is to be executed. The selection instructing unit 502 further instructs the cluster analyzing unit 505 as to which type of property amount clustering is to be performed by.

At a constant interval or at each user specified timing, the cluster modeling unit 507 performs modeling based on the specified types of property amounts for the most recent fixed period of time, stored in the property amount storage unit 506. As a modeling method, for example, a k-means method can be given as an example. For example, the cluster modeling unit 507 performs modeling by a k-means method to generate the information indicating the distribution range for each cluster depicted in FIGS. 1 and 2. The cluster modeling unit 507 further performs normalization concerning the information indicating the distribution ranges.

The transmitting unit 508 transmits to the control apparatus 300, information indicating the distribution ranges obtained by the cluster modeling unit 507. Alternatively, the transmitting unit 508 may transmit to the control apparatus 300, information indicating property amount distribution positions obtained by the cluster analyzing unit 505. Here, although the classifying apparatus 102 transmits to the control apparatus 300, information indicating distribution positions of property amounts or information indicating distribution ranges of property amounts, such information may be stored in a storage apparatus that can be accessed by both the control apparatus 300 and the classifying apparatus 102.

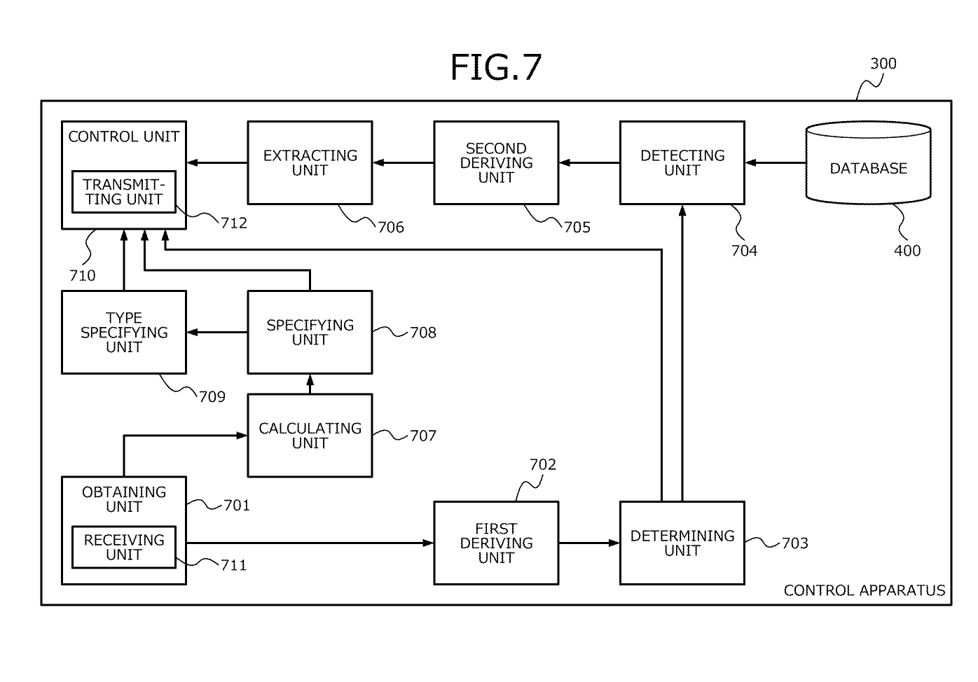

FIG. 7 is a block diagram depicting a functional configuration of the control apparatus. The control apparatus 300 includes an obtaining unit 701, a first deriving unit 702, a determining unit 703, a detecting unit 704, a second deriving unit 705, an extracting unit 706, a calculating unit 707, a specifying unit 708, a type specifying unit 709, and a control unit 710. Processes of the obtaining unit 701 to the control unit 710, more specifically, for example, are encoded in the control program stored in the storage apparatus 302. The CPU 301 reads out the control program from the storage apparatus 302 and executes the processes encoded in the control program whereby, processes of the obtaining unit 701 to the control unit 710 are realized. Alternatively, the CPU 301 may obtain the control program from the network NET via the network I/F 303. As depicted in FIG. 1, groups are referred to as clusters.

The obtaining unit 701 obtains for each cluster, information indicating distribution positions of property amounts in given data classified by the classifying apparatus 102 and stores the obtained information to a storage unit. As described with reference to FIG. 1, information that indicates distribution positions of property amounts may be normalized values of the property amounts, or information that indicates the distribution ranges of the property amounts. More specifically, the obtaining unit 701 may receive the information from the classifying apparatus 102 by a receiving unit 711 as depicted in FIG. 7, or may obtain from a storage apparatus accessible by the control apparatus 300, the information indicating the property amount distribution positions obtained from the classifying apparatus 102. Alternatively, if the control apparatus 300 is equipped with an input means, the control apparatus 300 may receive input of the information indicating property amount distribution positions obtained by the classifying apparatus 102.

The first deriving unit 702 derives based on the information obtained by the obtaining unit 701 and indicating the property amount distribution positions, information indicating the proximity of property amount distribution positions between clusters. As described with reference to FIG. 1, for example, the information indicating the proximity of distribution positions of the property amounts may be information that indicates the extent of overlap of distribution ranges, may be the distance between distribution positions that are closest, or may be the distance between the averages of distribution positions.

The determining unit 703 determines whether the information derived by the first deriving unit 702 and indicating the proximity satisfies a given condition. If the determining unit 703 determines that the given condition is satisfied, the control unit 710 performs control to cause the classifying apparatus 102 to classify data of the same type as the given data into a cluster among multiple clusters, according to the property amount of a type that differs from a given type among the property amounts of multiple types. More specifically, the control unit 710 transmits to the classifying apparatus 102, information indicating which type of property amount, clustering is to be based on and thereby, remotely controls the classifying apparatus 102.

Further, if the determining unit 703 determines that the given condition is satisfied, the control unit 710 performs control to cause the classifying apparatus 102 to classify data of the same type into a cluster among the multiple clusters, according to the property amount of a type that differs from the given type.

The detecting unit 704 detects from the database 400, the distribution position of each property amount of a different type, for the combination of clusters for which the information indicating the proximity is determined by the determining unit 703 to satisfy a given condition. In the example used in FIG. 1, the information indicating the proximity concerning the combination of cluster a and cluster b is determined by the determining unit 703 to satisfy a given condition, and the given types are the property amount X and the property amount Y. More specifically, the detecting unit 704 detects from the database 400, the distribution positions of the property amounts of types other than the property amount X and the property amount Y, for cluster a and cluster b, respectively.

The second deriving unit 705 derives for the specified combination, information that indicates the proximity of the property amount distribution positions detected by the detecting unit 704. More specifically, the second deriving unit 705 calculates for each type other than the property amount X and the property amount Y, the distance between the detected distribution positions for cluster a and cluster b. For example, when the information related to distribution positions and stored in the database 400 is information related to the distribution ranges of the property amounts, the distance between the distribution positions detected for cluster a and cluster b may be the distance between positions that are closest to each other in the respective distribution ranges. The distance between the closest positions is the limit of the clustering performance for the types by the classifying apparatus 102.

Alternatively, when the information related to distribution positions and stored in the database 400 is information related to the distribution ranges of property amounts, the distance between the distribution positions detected for cluster a and cluster b may be the distance between positions that are farthest from each other in the respective distribution ranges. Alternatively, for example, when the information related to distribution position and stored in the database 400 is multiple property amounts, the distance between the distribution positions detected for cluster a and cluster b is the farthest distance among the distances between property amount distribution positions.

The extracting unit 706 extracts from among the different types, a type for which the information that indicates the proximity and derived by the second deriving unit 705 satisfies a given condition. For example, when the information that indicates the proximity is the distance between positions that are closest to each other as described above, the given condition may be set as the greatest calculated distance, or may be set to an i-th distance in descending order of the calculated distances. Types for which the distance is farther between the positions that are closest to each other, have a higher classification accuracy for cluster a and cluster b. In the example depicted in FIG. 1, the property amount Z is extracted.

If the determining unit 703 determines that the given condition is satisfied, the control unit 710 performs control to cause the classifying apparatus 102 to classify data of the same type into a cluster among the multiple clusters. In the example depicted in FIG. 1, the control unit 710 performs control to cause the classifying apparatus 102 to classify data of the same type into a cluster, according to the property amount Z in addition to the property amount X and the property amount Y. As a result, clustering is performed by the property amount of a type presumed to improve classification accuracy among the various types, enabling the classification accuracy to be improved.

Description of the example depicted in FIG. 2 will be given using the functional units. The calculating unit 707 calculates for each combination of types, information that indicates the strength of correlation of the property amounts of the types included in the combination. The calculating unit 707 calculates the information based on the information that indicates the distribution positions of various types of property amounts obtained by the obtaining unit 701. As described with reference to FIG. 2, information that indicates the strength of correlation is, for example, a correlation coefficient.

The specifying unit 708 specifies from among the combinations of types, a combination for which the strength of correlation indicated by the information calculated by the calculating unit 707 is a predetermined strength or greater. For example, the specifying unit 708 specifies a combination for which the absolute value of the correlation coefficient is a threshold or greater, as a combination for which the information indicating the strength of correlation is a predetermined strength or greater. The predetermined strength, for example, is a strength specified by the user, or is pre-stored in the storage apparatus 302.

The control unit 710 performs control to cause the classifying apparatus 102 to classify the given data into a cluster, according to the property amount of a type excluding from the multiple types, any one of the types included in the combination specified by the specifying unit 708.

The type specifying unit 709 specifies the type for which the extent of variation of the property value is greater among the types included in the combination specified by the specifying unit 708. As described using FIG. 2, the extent of variation is calculated for each type as the sum of the lengths of each distribution range along a direction parallel to the type. The type specifying unit 709 specifies, as the type for which the extent of variation is greater, the type for which the sum is greater.

The control unit 710 performs control to cause the classifying apparatus 102 to classify the given data to a cluster, according to the property amount of a type excluding from the multiple types, the type specified by the type specifying unit 709. More specifically, the control unit 710 may transmit to the classifying apparatus 102 by a transmitting unit 712, information indicating according to which type of property amount clustering is to be performed, and thereby remotely controls the classifying apparatus 102.

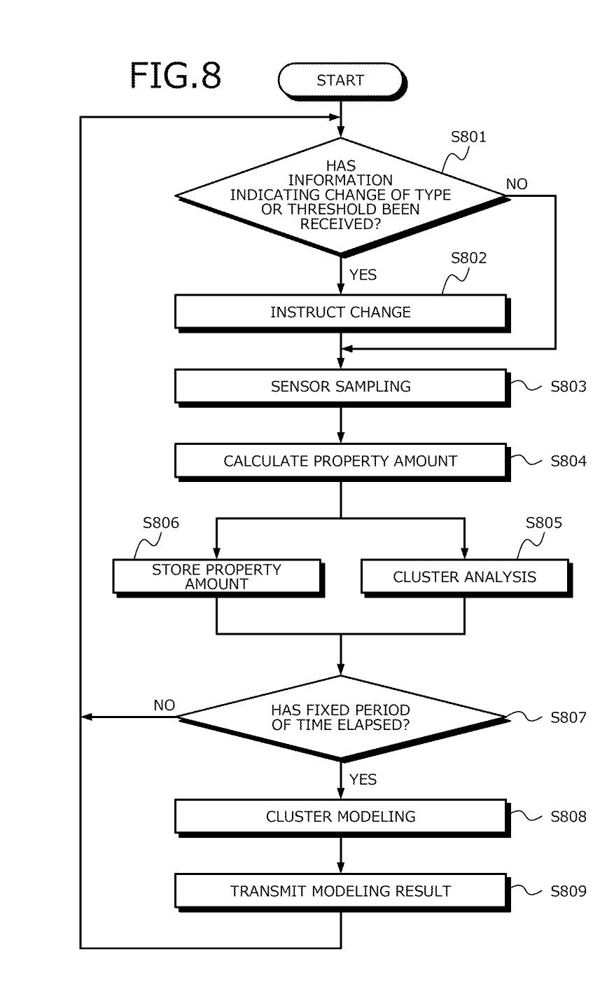

FIG. 8 is a flowchart depicting an example of a procedure of a clustering process by the classifying apparatus. The classifying apparatus 102 determines whether information indicating a change of the type or threshold has been received (step S801). If information indicating a change of the type or threshold has been received (step S801: YES), the classifying apparatus 102 instructs the units of the change of the type or threshold (step S802), and performs sensor sampling (step S803). If information indicating a change of the type or threshold has not been received (step S801: NO), the classifying apparatus 102 transitions to step S803.

The classifying apparatus 102 calculates the property amount based on detection results obtained by the sensor sampling (step S804), performs cluster analysis based on the calculated property amount (step S805), and stores the calculated property amount to a storage apparatus (step S806). Subsequent to steps S805 and S806, the classifying apparatus 102 determines whether a fixed period of time has elapsed since the previous cluster modeling was performed (step S807).

If the fixed period of time has elapsed (step S807: YES), the classifying apparatus 102 performs cluster modeling (step S808), transmits the modeling result to the control apparatus 300 (step S809), and returns to step S801. The modeling result is the information indicating the distribution ranges of the property amounts for each cluster, described above. If the fixed period of time has not elapsed (step S807: NO), the classifying apparatus 102 returns to step S801.

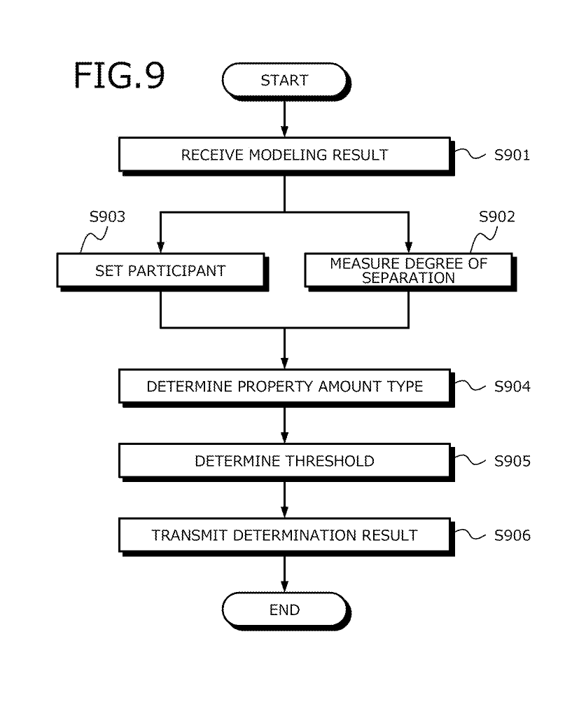

FIG. 9 is a flowchart depicting an example of a procedure of a control process by the control apparatus. The control apparatus 300 receives a modeling result from the classifying apparatus 102 (step S901). The modeling result is the information indicating the distribution ranges of the property amounts for each cluster, described above. The control apparatus 300 measures the degree of separation (step S902), and sets a participant from among participant candidates, based on the modeling result (step S903).

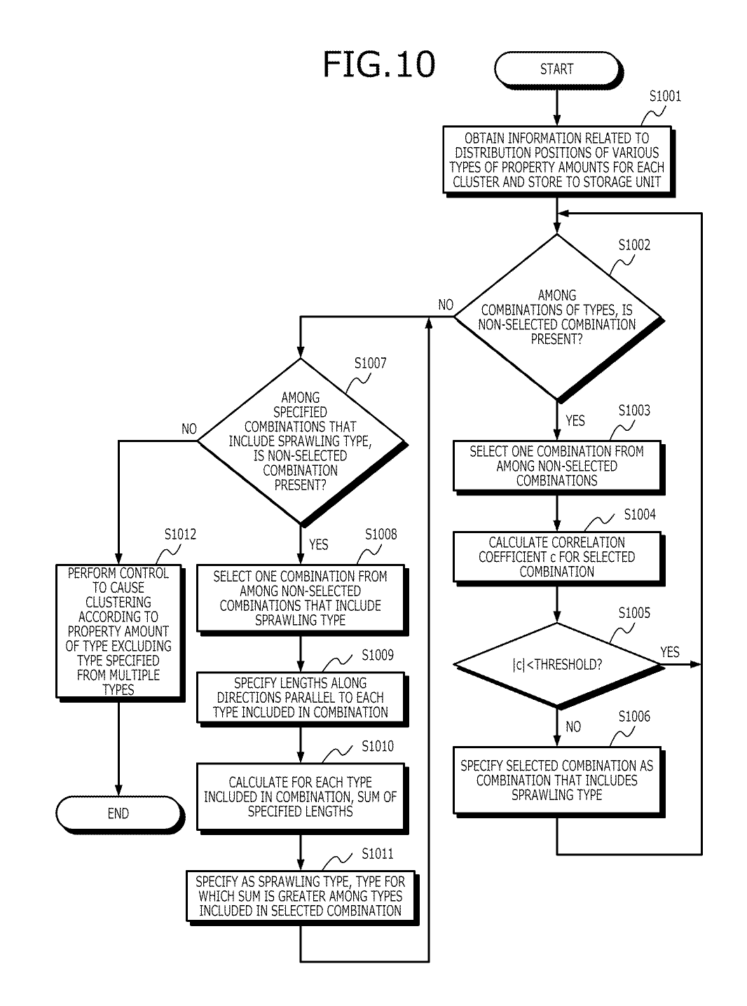

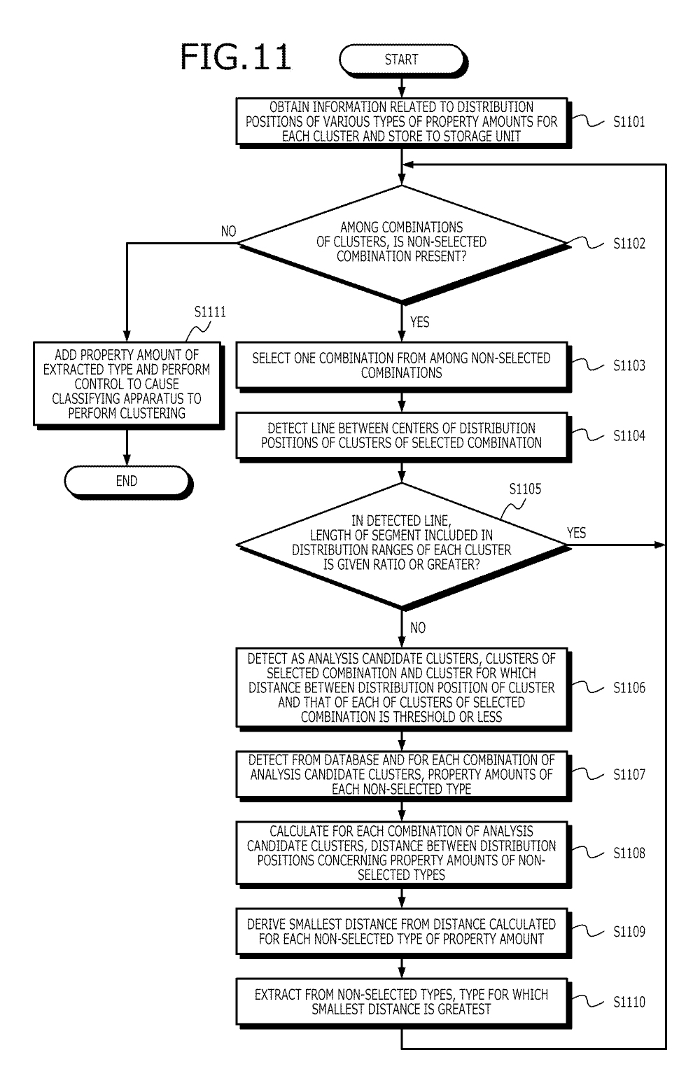

The control apparatus 300 determines the property amount type based on the set participant and measured degree of separation (step S904), and determines the threshold for when clustering is performed (step S905). The control apparatus 300 transmits determination results to the classifying apparatus 102 (step S906), and ends a series of the operations. Details of step S903 and step S904 will be described using FIGS. 10 and 11.

FIG. 10 is a flowchart depicting an example of details of the procedure of the control process by the control apparatus. The control apparatus 300 obtains information related to the distribution positions of various types of property amounts for each cluster and stores the obtained information to a storage unit (step S1001). The storage unit, for example, is the storage apparatus 302. The control apparatus 300 determines whether among combinations of the types, a non-selected combination is present (step S1002). Here, the types are the types of property amounts when the obtained information related to the distribution positions is clustered.

If a non-selected combination is present (step S1002: YES), the control apparatus 300 selects one combination from among the non-selected combinations (step S1003). The control apparatus 300 calculates a correlation coefficient c for the selected combination (step S1004), and determines whether |c|<threshold is true (step S1005).

If |c|<threshold is not true (step S1005: NO), the control apparatus 300 specifies the selected combination as a combination that includes a sprawling type (step S1006), and returns to step S1002. If |c|<threshold is true (step S1005: YES), the control apparatus 300 returns to step S1002.

On the other hand, at step S1002, if no non-selected combination is present (step S1002: NO), the control apparatus 300 determines whether among the specified combinations that include a sprawling type, a non-selected combination is present (step S1007). If a non-selected combination is present (step S1007: YES), the control apparatus 300 selects one combination from among the non-selected combinations that include a sprawling type (step S1008). The control apparatus 300 specifies based on information indicating the distribution range of each cluster, lengths along directions parallel to each type included in the selected combination (step S1009).

The control apparatus 300 calculates for each type included in the combination, a sum of the specified lengths (step S1010). The control apparatus 300 specifies as a sprawling type for which the extent of variation is large, the type for which the sum is greater among the types included in the selected combination, (step S1011), and returns to S1007. If no non-selected combination is present (step S1007: NO), the control apparatus 300 performs control to cause clustering according to the property amount of a type excluding the type specified from multiple types (step S1012), and ends a series of operations. The control apparatus 300 has been described to control the classifying apparatus 102 at step S1012; however, if the classifying apparatus 102 and the control apparatus 300 are the same apparatus, the clustering is simply according to the property amount of a type excluding the type specified from the multiple types.

FIG. 11 is a flowchart depicting another example of the details of the procedure of the control process by the control apparatus. The control apparatus 300 obtains information related to the distribution positions of various types of property amounts for each cluster and stores the obtained information to the storage unit (step S1101). The control apparatus 300 determines whether among combinations of the clusters, a non-selected combination is present (step S1102). The storage unit, for example, is the storage apparatus 302. If among the combinations of clusters, a non-selected combination is present (step S1102: YES), the control apparatus 300 selects one combination from among the non-selected combinations (step S1103).

The control apparatus 300 detects a line between centers of the distribution positions of the clusters of the selected combination (step S1104), and determines if in the detected line, the length of a segment included in the distribution ranges of each cluster is a given ratio or greater (step S1105). The given ratio is, for example, a ratio specified by the user or pre-stored in the storage apparatus 302. In the detected line, if the length of a segment included in the distribution ranges of each cluster is the given ratio or greater (step S1105: YES), the control apparatus 300 returns to step S1102. In the detected line, if the length of a segment that is included in the distribution ranges of each cluster is not the given ratio or greater (step S1105: NO), the control apparatus 300 transitions to step S1106. The control apparatus 300 detects as analysis candidate clusters, the clusters of the selected combination and a cluster for which distance between the distribution position of the cluster and that of each of the clusters of the selected combination is a threshold or less (step S1106).

The control apparatus 300 detects from a database and for each combination of analysis candidate clusters, the property amounts of each non-selected type (step S1107). The control apparatus 300 calculates for each combination of analysis candidate clusters, the distance between the distribution positions concerning the property amounts of the non-selected types (step S1108). Here, a non-selected type indicates among the types that can be calculated by the classifying apparatus 102, among the types of property amounts that the data has, a type that is not used in the classification result obtained at step S1101.

The control apparatus 300 derives the smallest distance from the distance calculated for each non-selected type of property amount (step S1109), extracts from the non-selected types, the type for which the smallest distance is the greatest (step S1110), and returns to step S1102.

At step S1102, if no non-selected combination is present (step S1102: NO), the control apparatus 300 adds the property amount of the extracted type and performs control to cause the classifying apparatus 102 to perform clustering (step S1111), and ends a series of the operations. The control apparatus 300 is described to control the classifying apparatus 102 at step S1111; however, if the classifying apparatus 102 and the control apparatus 300 are the same apparatus, the property amount of the extracted type is simply added and clustering is performed.

As described, the control apparatus uses the classifying result obtained by the classifying apparatus by classifying given data such as audio data, according to the property amount of a given type, and if the distribution positions of the property amounts between groups are close, performs control to cause the classifying apparatus to change the type of property amount to classify subsequent data. As a result, classification accuracy can be improved.

The control apparatus may cause the classifying apparatus to increase the types of property amounts to classify the subsequent data if the distribution positions of the property amounts between groups are close. As a result, classification accuracy can be improved.

The control apparatus may cause the classifying apparatus to increase the types presumed to enable classification into groups whose distribution positions are close and classify the subsequent data. As a result, classification accuracy can be improved to a greater extent than in a case where a type is added that is randomly selected from among non-selected types. Further, since control can be performed that enables the least number of types to be added, increases in the power consumption of the classifying apparatus can be controlled and the communication volume can be reduced when the classifying apparatus transmits to the control apparatus, information indicating the distribution positions of the property amounts.

The classifying apparatus transmits to the control apparatus, as information related to the distribution positions of the property amounts, information related to the distribution ranges of the property amounts; and the control apparatus obtains the information related to the distribution ranges of the property amounts. As a result, the communication volume when data is transmitted from the classifying apparatus to the control apparatus can be reduced.

The control apparatus uses, as information indicating the proximity of distribution positions between groups, the extent of overlap of the distribution ranges of the property amounts. As a result, the volume of calculations at the control apparatus can be reduced, enabling reductions in power consumption.

As described above, according to the control method, the control program, and the control apparatus, a combination for which the degree of correspondence is high for types of property amounts that the data has is specified from among combinations of types. Further, the control apparatus performs control to cause the classifying apparatus to classify data according to the property amount of a type exclusive of one of the types included in the combination specified from multiple types. As a result, classification accuracy can be maintained while the types of property amounts are reduced. Since the calculation volume for the property amounts by the classifying apparatus can be reduced, power consumption of the classifying apparatus can be reduced. Further, the communication volume can be reduced when the classifying apparatus transmits to the control apparatus, information that indicates the distribution positions of the property amounts.

The control apparatus performs control to cause the classifying apparatus to classify data according to the property amount of a type excluding from the multiple types, the type for which the extent of variation of the property amount is greater among the types included in the combination for which the correspondence degree is high.

The control method and the classifying method described in the present embodiment can be realized by executing the control program and the classifying program on a computer such as a personal computer (PC), a server, workstation and the like. The control program and the classifying program are stored on a non-transitory, computer-readable recording medium such as a hard disk, a CD-ROM, a DVD, USB memory, flash memory. Further, the control program and the classifying program may be distributed through a network such as the Internet.

The control apparatus described in the present embodiment can be realized by an application specific integrated circuit (ASIC) such as a standard cell or a structured ASIC, or a programmable logic device (PLD) such as a field-programmable gate array (FPGA). Specifically, for example, functional units of the control apparatus are defined in hardware description language (HDL), which is logically synthesized and applied to the ASIC, the PLD, etc., thereby enabling manufacture of the control apparatus.

The classifying apparatus described in the present embodiment can be realized by a standard cell, an ASIC, or a PLD such as a FPGA. More specifically, for example, functions of the classifying apparatus described above are defined in HDL, which is logically synthesized and applied to the ASIC, the PLD, etc., thereby enabling manufacture of the classifying apparatus.

In the present embodiment, although the data classified by the classifying apparatus is assumed to be audio data, configuration is not limited hereto. Further, in the present embodiment, although cluster candidates are assumed to be people such as participants in a meeting, configuration is not limited hereto.

According to one aspect of the present embodiment, classification accuracy can be improved.

All examples and conditional language provided herein are intended for pedagogical purposes of aiding the reader in understanding the invention and the concepts contributed by the inventor to further the art, and are not to be construed as limitations to such specifically recited examples and conditions, nor does the organization of such examples in the specification relate to a showing of the superiority and inferiority of the invention. Although one or more embodiments of the present invention have been described in detail, it should be understood that the various changes, substitutions, and alterations could be made hereto without departing from the spirit and scope of the invention.

What is claimed is:

1. A control method executed by a computer that classifies given data into a group among a plurality of groups, the computer classifying the given data according to a property amount of a given type among property amounts of various types that the given data has and storing the given data to a storage device, the control method comprising:
writing to the storage device and for each group among the plurality of groups, information that indicates distribution positions of the property amounts in the classified given data;
calculating based on the written information that indicates the distribution positions of the property amounts, information that indicates a proximity of the distribution positions of the property amounts between groups among the plurality of groups; and
classifying data of a same type as the given data into a group among the plurality of groups, according to a property amount of a different type from the given type among the various types of property amounts, when the calculated information that indicates the proximity between the distribution positions satisfies a given condition, and storing the data to the storage device.

2. The control method according to claim 1, wherein
the classifying and storing to the storage device includes when the given condition is satisfied, classifying the data of the same type into a group among the plurality of groups, according to the property amount of the given type and the property amount of the different type, and storing the data to the storage device.

3. The control method according to claim 1, further comprising:
detecting from a storage apparatus configured to store the distribution positions of the property amounts of the various types for each group among the plurality of groups, the property amount of each different type, for a combination of groups for which the information that indicates the proximity satisfies the given condition;
calculating for the combination of groups satisfying the given conditions, information indicating a proximity between the distribution positions of the detected property amounts;
extracting from among the different types, a type for which the calculated information indicating the proximity satisfies the given condition; and
executing a process, wherein
the classifying and storing includes when the computer determines that the given condition is satisfied, classifying the data of the same type into a group among the plurality of groups, according to the property amount of the extracted type, and storing the data to the storage device.

4. The control method according to claim 1, wherein
the information indicating the distribution positions of the property amounts, is information indicating distribution ranges of the property amounts.

5. The control method according to claim 4, wherein
the information indicating the proximity of the distribution positions of the property amounts is an extent of overlap of the distribution ranges of the property amounts.

6. A control method executed by a computer that classifies given data into a group among a plurality of groups, the computer classifying the given data according to a property amount of a given type among property amounts of various types that the given data has and storing the given data to a storage device, the control method comprising:
writing to the storage device, information that indicates distribution positions of property amounts of a plurality of types in a plurality of data of a same type as the given data;
calculating based on the written information that indicates the distribution positions of the property amounts of the plurality of types and for each combination of the plurality of types, information that indicates a strength of correlation of the property amounts of the types included in the combination;
specifying from among the combinations of the plurality of types, a combination for which the strength of correlation indicated by the calculated information is a predetermined strength or greater; and
classifying the given data into a group of the plurality of groups, according to a property amount of a type excluding from among the plurality of types, any one among the types included in the specified combination, and storing the given data to the storage device.

7. The control method according to claim 6, wherein
the classifying and storing includes classifying the given data into a group among the plurality of groups, according to the property amount of a type excluding from among the plurality of types, the type for which an extent of variation of the distribution position indicated by obtained information is greater among the types included in the specified combination.

8. A control apparatus that controls a classifying apparatus that classifies given data into a group among a plurality of groups, according a property amount of a given type among property amounts of various types that the given data has, the control apparatus comprising
a processor configured to:
obtain for each group among the plurality of groups, information that indicates distribution positions of the property amounts in the given data classified by the classifying apparatus and store the obtained information to a storage device;
derive based on the information stored to the storage device, information that indicates a proximity of the distribution positions of the property amounts between groups among the plurality of groups;
determine whether the derived information that indicates the proximity satisfies a given condition; and
perform control to cause the classifying apparatus to classify data of a same type as the given data into a group among the plurality of groups, according to a property amount of a different type from the given type among the various types of property amounts, upon determining that the given condition is satisfied.

9. A control apparatus that controls a classifying apparatus that classifies given data into a group among a plurality of groups, according to property amounts of a plurality of types that the given data has, the control apparatus comprising
a processor configured to:
obtain information that indicates distribution positions of the property amounts of the plurality of types that each data among a plurality of data of a same type as the given data has and store the obtained information to a storage device;
calculate based on the information stored to the storage device and for each combination of the plurality of types, information that indicates a strength of correlation of the property amounts of the types included in the combination;
specify from among the combinations of the plurality of types, a combination for which the strength of correlation indicated by the calculated information is a predetermined strength or greater; and
perform control to cause the classifying apparatus to classify the given data into a group among the plurality of groups, according to a property amount of a type excluding from among the plurality of types, any one among the types included in the specified combination.
